(19) United States
(12) Patent Application Publication
(10) Pub. No.: US 2004/0185153 A1
(43) Pub. Date: Sep. 23, 2004

(54) Treatment for packaged meat, fish and poultry and particularly red meat

(76) Inventor: Ihab M. Hekal, Greenwich, CT (US)

Correspondence Address: Law Offices of William H. Holt, Unit 2 - First Floor, 1423 Powbatan Street, Alexandria, VA, 22314, US

(21) Appl. No.: 10/735,421

(22) Filed: Dec. 12, 2003

Related U.S. Application Data
(60) Provisional application No. 60/432,673, filed on Dec. 12, 2002.

(51) Int. Cl. C12C 3/04

(52) U.S. Cl. 426/392

(57) ABSTRACT

Treatment of food products including meats, poultry and fish by packaging the products in a confined container with cuprous compounds in combination with mixtures of CO, CO₂ and N₂ and utilizing a sachet or sachets including an oxygen absorber and a carbon monoxide absorber.

### BACKGROUND OF THE INVENTION

The invention relates to a treatment for packaged food product, particularly meat, fish and poultry products, and more particularly to a treatment for beef, tuna fish and other red meat, fish and poultry products.

The use of various gases for treating food is old and well known. Packaging of food in a modified atmosphere comprised of a mixture of carbon dioxide (CO₂) and nitrogen (N₂), with a small amount of carbon monoxide (CO) has been known to increase shelf life and also produce a bright red color to red meat, such as beef, and the like. It seems that customers have the perception that the bright red color is indicative of freshness and enhanced flavor and therefore are more likely to purchase such a product.

The food to be treated is usually placed in a tray, such as a Styrofoam tray, wrapped with transparent plastic film, and then placed in a barrier bag. The interior of the bag is flushed with the modified atmosphere of gases to get rid of oxygen in the food tray. Typically, an oxygen absorber sachet is inserted within the modified atmosphere to get rid of any residual oxygen entrapped in the tray. When the packages are delivered to the store or other place of sale or use, personnel remove the tray of food from the package and place the food on a refrigerated shelf to preclude or minimize spoilage prior to cooking.

The Food and Drug Administration (FDA) and the U.S. Department of Agriculture (USDA) have approved the addition of 0.4% carbon monoxide gas to the modified atmosphere used during the packaging of meat, fish and poultry. Trays of such foods are presently packaged in a modified atmosphere which comprises gas volumes in the range of 70% Co₂ and 30% N₂, and a small amount of CO on the order of 0.4%. The CO reacts with moisture in the meat to enhance its red color and is particularly effective in enhancing the red color of beef, and the like. When the meat is exposed to the CO for a considerable length of time, the red carboxyhemoglobin color of the food product becomes the predominate color. This color is relatively stable so that, when the treated meat is cooked, the inside of the piece of meat does not change its color, but remains a bright red. This phenomenon is, however, not desirable to many consumers who have the mistaken impression that the meat is undercooked and is too rare.

### SUMMARY OF THE INVENTION

The present invention has been arrived at in order to overcome the undesirable features of the prior art and is primarily intended to further treat the meat so that, upon cooking, the interior of the meat does not retain the earlier enhanced red color. The novel results obtained by the invention are brought about through the use of various compounds of cuprous chloride or cuprous bromide for absorbing the small amount of carbon monoxide from the packaged food product.

### DESCRIPTION OF PREFERRED EMBODIMENTS

In one preferred embodiment, the invention contemplates the use of various halogen cuprous compounds such as cuprous chloride, cuprous bromide, cuprous sulfate, or in combination of aluminum tri-chloride, or tri-bromide, and preferably cuprous aluminum tetrachloride (CuAlCl₄). The compounds can be deposited on a macro-reticular resin, or charcoal, or suspended in polystyrene beads and packed into gas permeable sachets. When assembled with the meat that has been packaged in the modified atmosphere of CO₂, N₂ and CO and wrapped in plastic wrap, or treated paper, etc., the sachet will begin to absorb carbon monoxide from the surrounding atmosphere within the package. By the time that the sachet absorbs all of the CO in the modified atmosphere within the package, only a few molecular layers of red carboxyhemoglobin will have been formed on the surface of the meat, without any deep penetration into the inside portion of the meat. The outer surface of the meat does, however, acquire the desired red color. The result of this treatment is that, upon cooking of the meat, the outside surface, and the inside portion thereof, will take on the usual brown color which occurs in cooked meat that has not been treated with the foregoing processes.

The carbon monoxide permeable sachet containing the cuprous chloride compound can be added to the external package of food in the modified atmosphere and protected with barrier plastic wrap to minimize oxygen from the surrounding air from reaching the packaged food. The food can be packaged in a tray, and the tray is wrapped with micro-perforated plastic film and placed within the barrier bag which contains the modified atmosphere.

A further feature of the present invention is the provision of a dual compartment sachet having an oxygen absorber in one compartment and a carbon monoxide absorber in the other compartment.

It is also contemplated that a single compartment, gas permeable, sachet can contain both an oxygen absorber and a carbon monoxide absorber.

The amount of cuprous chloride compound to be placed in the sachet will, of course, depend upon the weight and/or volume of the packaged food. It has been found that one gram of the compound will be sufficient to treat a kilogram of beef, and similar meat products. This amount is also variable dependent upon the time of exposure to the carbon monoxide during the packaging operation.

An experiment for confirming the effect of the cuprous chloride will be described next. 25 ml of concentrated hydro-chloride was diluted with distilled water in a 250 ml flask with a suitable stopper to obtain 100 ml of 3 mol hydro-chloride aqueous solution. To the solution, 16 g of anhydrous cuprous chloride was added to obtain 1.6 mol cuprous chloride solution in 3 mol hydro chloride aqueous solution. The solution exhibited deep green in color. When the gaseous carbon monoxide was bubbled in the mixture, the cuprous chloride in the mixture reacted with the carbon monoxide to form water soluble Cu(CO)Cl(H₂O)₂. Through this reaction, it was possible to determine an amount of carbon monoxide in a given gas mixture absorbed by the cuprous chloride. Several syringes containing gas mixtures with different carbon monoxide contents were prepared. 30 ml of 1.6 mol cuprous chloride solution was sucked into each of the syringes. After attaching a cap to each syringe, each syringe was vigorously shaken to promote the reaction between the cuprous chloride and the carbon monoxide. It was necessary to shake the syringe vigorously, as carbon monoxide is almost insoluble in water. Within 30 seconds, the carbon monoxide completely reacted with the cuprous chloride. A volume of remaining gas in the syringe was measured, and compared with the volume of the original gas to determine the amount of the carbon monoxide absorbed by the cuprous chloride. Through this experiment, it was found that the 1.6 mol cuprous chloride solution can react with the gaseous carbon monoxide in a 1:1 volume ratio, i.e. 1 ml of solution versus 1 ml of carbon monoxide.

In summary, the foregoing description provides for four related inventions:

1. The use of cuprous chloride in any of various forms as a packaging agent in combination with the modified atmosphere during packaging of CO₂, N₂ and CO, is believed to be a novel invention.

2. The use of a sachet containing a cuprous chloride compound, in combination with packaged meat that has been packaged while in an atmosphere of CO₂, N₂ and CO, is believed to be a novel invention.

3. The use of a sachet with two compartments, one filled with an oxygen absorber and the other with a carbon monoxide absorber is believed to be a novel invention.

4. The use of a single sachet containing both an oxygen absorber and a carbon monoxide absorber is believed to be a novel invention.

The foregoing descriptions describe the invention in the form of particular uses and embodiments but it is to be understood that the following claimed subject matter defines the metes and bounds of the invention and is intended to cover the disclosed invention and equivalents thereof.

I claim:

1. A treatment for a packaged food product comprising the steps of filling a gas selected from the group consisting of CO₂, N₂ and CO in a confined container; placing said food product into said confined container; and introducing a compound into said confined container for absorbing carbon monoxide.

2. The method as defined in claim 1 wherein said compound is comprised of cuprous chloride.

3. The method as defined in claim 1 wherein said compound is comprised of cuprous bromide.

4. The method as defined in claim 1 wherein said compound is comprised of cuprous sulfate.

5. The method as defined in claim 1 wherein said compound is comprised of cuprous aluminum tri-chloride.

6. The method as defined in claim 1 wherein said compound is comprised of cuprous aluminum tetra-chloride.

7. The method as defined in claim 1 wherein said compound is comprised of cuprous aluminum tri-bromide.

8. The method as defined in claim 1 wherein said compound is comprised of cuprous aluminum tetra-bromide.

9. The method as defined in claim 1 wherein said compound is contained in a sachet for avoiding contact with said food product.

10. The method as defined in claim 1 further comprising the step of placing an oxygen absorber in said confined container.

11. The method as defined in claim 10 wherein said oxygen absorber is contained in a sachet for avoiding contact with said food product.
